(19) United States
(12) Patent Application Publication
(10) Pub. No.: US 2026/0078599 A1
(43) Pub. Date: Mar. 19, 2026

(54) FLOOD VENT AND A FLOAT FOR A FLOOD VENT

(71) Applicant: Smart Vent Products LLC, Juno Beach, FL (US)

(72) Inventor: Michael J. Graham, Jupiter, FL (US)

(73) Assignee: Smart Vent Products LLC, Juno Beach, FL (US)

(21) Appl. No.: 18/886,061

(22) Filed: Sep. 16, 2024

(51) Int. Cl. E04H 9/14; F16K 24/04

(52) U.S. Cl. CPC E04H 9/145; F16K 24/044

(57) ABSTRACT

According to one example, a float, such as the float for a door of a flood vent, includes a front surface, a back surface, two side surfaces, a top surface, and a bottom surface. The float further includes a first closed slot positioned in the front surface, a second closed slot positioned in the back surface, and a pin that extends outward from a first side surface of the two side surfaces.

### TECHNICAL FIELD

This disclosure relates generally to flood water control devices and more particularly to a flood vent and a float for a flood vent.

### BACKGROUND

Typically, one or more flood vents may be installed into an opening in a structure (such as a building) in order to provide for equalization of interior and exterior hydrostatic forces caused by flooding fluids, such as water. Such typical flood vents may include a flood vent door that may open to allow flooding fluids to pass into or out of the structure through the flood vent, but that may prevent animals or other pests from entering or exiting the structure through the flood vent. These typical flood vents, however, may be deficient.

### SUMMARY

According to one example, a flood vent includes a frame that can, when installed in an opening in a structure, form a fluid passageway through the opening in the structure. The flood vent further includes a door that can be pivotally mounted to the frame, a first float positioned partially within the door, and a second float positioned partially within the door. The first float and the second float each include a front surface, a back surface, two side surfaces, a top surface, and a bottom surface. Additionally, the first float and the second float each include a first closed slot positioned in the front surface, a second closed slot positioned in the back surface, and a pin that extends outward from a first side surface of the two side surfaces so as to extend out of the door.

In some examples, the first float and the second float each include a second pin that extends outward from a second side surface of the two side surfaces.

In some examples, the first float and the second float each include a tab that is positioned on and extends upward from the top surface. In some examples of this, the tab includes a flat front surface and a flat back surface. In other examples of this, the first float and the second float each include a third closed slot positioned in a front surface of the tab, and a fourth closed slot positioned in a back surface of the tab.

In some examples, each of the first closed slot and the second closed slot of each of the first float and the second float is shaped as a portion of a cylinder. In some examples, each of the first closed slot and the second closed slot of each of the first float and the second float has a height of 1-2 inches, a width of 0.25-0.75 inches, and a depth of 0.02-0.06 inches. In some examples, each of the first closed slot and the second closed slot of each of the first float and the second float has a height that is ⅓-¾ of a height of a respective float of the first float and the second float, a width that is ¼-½ of a width of the respective float of the first float and the second float, and a depth that is 1/75- 1/25 of a depth of the respective float of the first float and the second float.

In some examples, the first float and the second float are each made from polypropylene, cork, or foam (or another material with a specific gravity less than 1, or a combination of materials with a specific gravity less than 1).

According to another example, a float, such as the float for a door of a flood vent, includes a front surface, a back surface, two side surfaces, a top surface, and a bottom surface. The float further includes a first closed slot positioned in the front surface, a second closed slot positioned in the back surface, and a pin that extends outward from a first side surface of the two side surfaces.

In some examples, the float further includes a second pin that extends outward from a second side surface of the two side surfaces.

In some examples, the float further includes a tab that is positioned on and extends upward from the top surface. In some examples of this, the tab includes a flat front surface and a flat back surface. In other examples of this, the float further includes a third closed slot positioned in a front surface of the tab, and a fourth closed slot positioned in a back surface of the tab.

In some examples, each of the first closed slot and the second closed slot is shaped as a portion of a cylinder. In some examples, each of the first closed slot and the second closed slot has a height of 1-2 inches, a width of 0.25-0.75 inches, and a depth of 0.02-0.06 inches. In some examples, each of the first closed slot and the second closed slot has a height that is ⅓-¾ of a height of the float, a width that is ¼-½ of a width of the float, and a depth that is 1/75- 1/25 of a depth of the float.

In some example, the float is made from polypropylene, cork, or foam (or another material with a specific gravity less than 1, or a combination of materials with a specific gravity less than 1).

Certain examples of the disclosure may provide one or more advantages. For example, the float includes a slot that may collect fluids (e.g., water) and direct the fluids upwards along a front surface (or back surface) of the float. In some examples, this direction of the fluids (and the resulting force) may cause the float to at least partially tip over, which can assist in releasing the door of a flood vent. This allows, in some examples, the door to be released more consistently, such as, for example, consistently at a water level of approximately 3 inches. Additionally, in some examples, this allows the door to be released at a lower average water level, such as, for example, an average water level of approximately 3 inches.

Certain examples of the disclosure may include none, some, or all of the above advantages. One or more other advantages may be readily apparent to one skilled in the art from the figures, descriptions, and claims included herein.

### BRIEF DESCRIPTION OF THE FIGURES

For a more complete understanding of the present disclosure and its features and advantages, reference is now made to the following description, taken in conjunction with the accompanying drawings, in which:

FIG. 1A is a front view of a door of an example flood vent.

FIG. 1B is a side view of the door of FIG. 1A.

FIG. 2A is a front view of a frame of an example flood vent.

FIG. 2B is a side view of the frame of FIG. 2A.

FIG. 3A is a side cross-sectional view of an example flood vent, showing the float lifting upward from a resting position to a raised position in reaction to an increasing fluid level.

FIG. 3B is a side cross-sectional view of an example flood vent, showing the door pivoting open after a float has released the door.

FIG. 3C is a front cross-sectional view of an example door of a flood vent having two floats positioned in the door.

FIG. 4A is a perspective view of an example float;

FIG. 4B is a side view of the float of FIG. 4A;

FIG. 4C is a top view of the float of FIG. 4A;

FIG. 4D is a bottom view of the float of FIG. 4A;

FIG. 4E is a front view of the float of FIG. 4A;

FIG. 4F is a side cross sectional view of the float of FIG. 4A, taken along section line A-A of FIG. 4E;

FIG. 5 is a perspective view of another example of a float;

FIG. 6 is a perspective view of a further example of a float; and

FIGS. 7A-7E are side cross-sectional views sequentially illustrating an example of a door of a flood vent being opened by the force of a flowing fluid.

### DETAILED DESCRIPTION

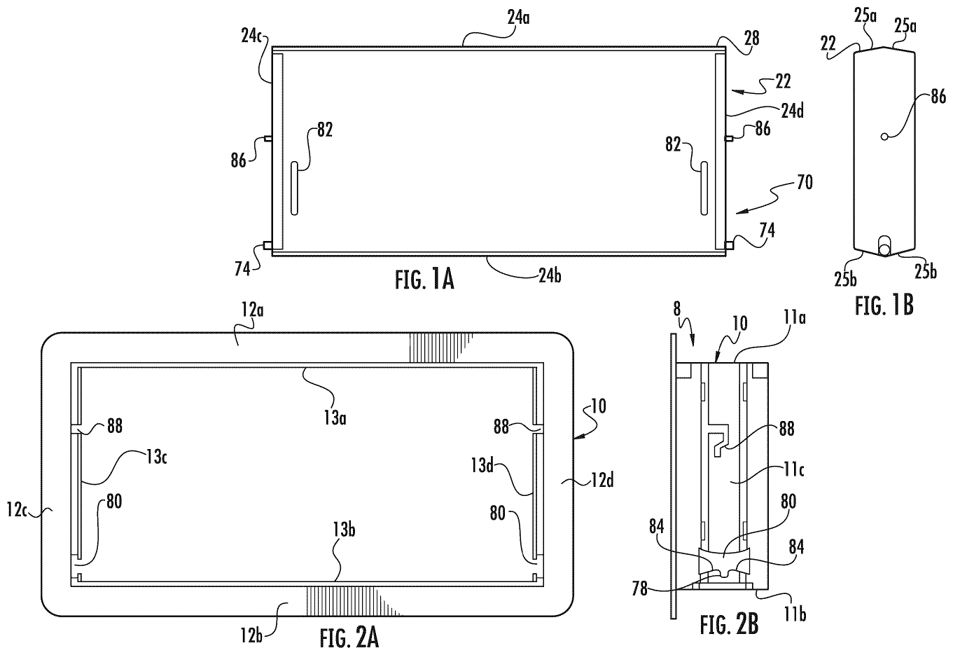

Examples of the present disclosure are best understood by referring to FIGS. 1A-7E of the drawings, like numerals being used for like and corresponding parts of the various drawings.

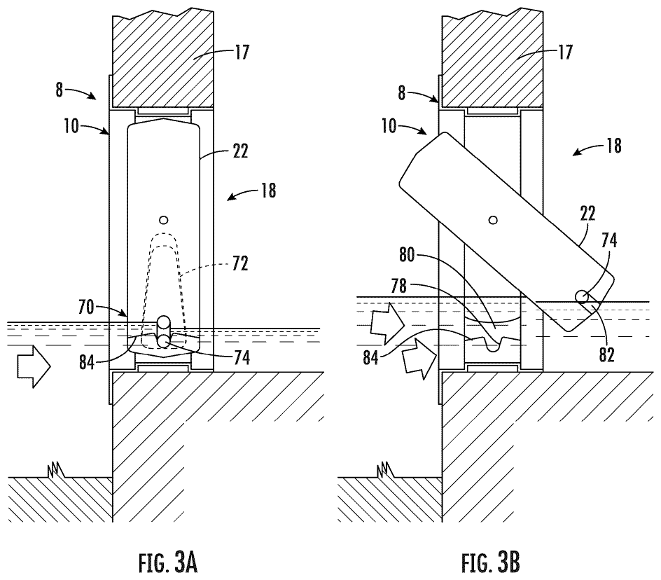

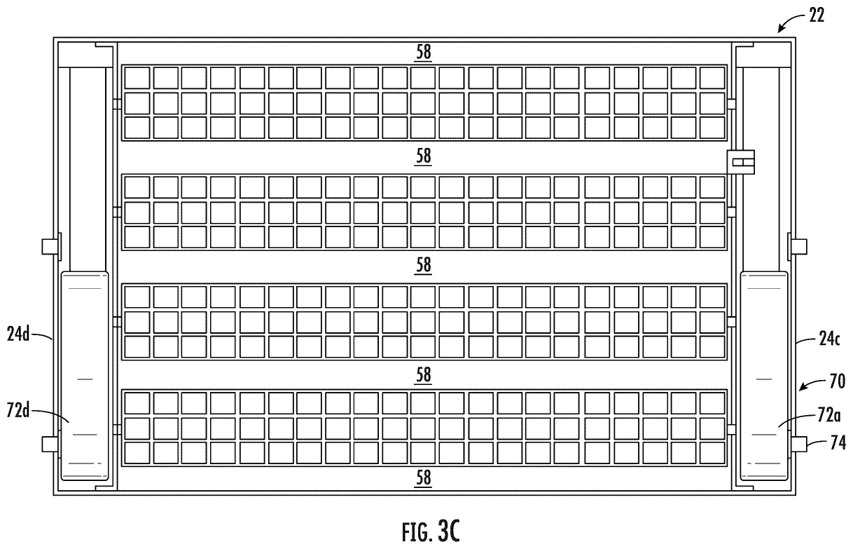

FIGS. 1A-2B illustrate an example of a flood vent 8. In some examples, the flood vent 8 is inserted (or otherwise installed) into an opening in a structure, such as an opening in a building, a wall, a foundation, a basement, a garage, a foyer, an entry, any structure located below base flood plain levels, any other structure, or any combination of the preceding. An example of the flood vent 8 inserted (or otherwise installed) into an opening in a structure is illustrated in FIGS. 3A-3B, which illustrate the flood vent 8 as being inserted (or otherwise installed) into opening 18 in structure 17. In the illustrated example, the flood vent 8 provides an entry point and/or exit point in the structure 17 for flooding fluids, such as water. As such, the flood vent 8 provides equalization of interior and exterior hydrostatic forces caused by the flooding fluids, in some examples. The flood vent 8 complies with various building code and federal government regulations that mandate that buildings with enclosed spaces located below base flood plain levels, such as crawl spaces, must provide for automatic equalization of interior and exterior hydrostatic forces caused by flooding fluids, in some examples. According to these regulations, flooding fluids must be permitted to enter and exit the enclosed spaces freely using flood venting.

In the example illustrated in FIGS. 1A-2B, the flood vent 8 includes a frame 10 (shown in FIGS. 2A-2B) and a door 22 (shown in FIGS. 1A-1B). When inserted (or otherwise installed) into an opening in a structure, the frame 10 forms a fluid passageway through the opening in the structure, thereby allowing the flooding fluids to enter and/or exit the structure, in some examples. The frame 10 (and the door 22) may be inserted (or otherwise installed) on the exterior of a structure (e.g., exterior of a building) and/or the interior of the structure (e.g., interior of a building). In the example illustrated in FIGS. 2A-2B, the frame 10 includes a top edge 11a, a bottom edge 11b, and two side edges 11c and 11d (not shown). These edges 11 define an outer perimeter of the frame 10, in the illustrated example. In the example illustrated in FIGS. 2A-2B, the frame 10 further includes a top rail 12a, a bottom rail 12b, and side rails 12c and 12d. When the flood vent 8 is inserted (or otherwise installed) in the opening in the structure, the edges 11 of the frame 10 are positioned (entirely or partially) within the opening of the structure (an example of which is seen in FIG. 3A), and the rails 12 are positioned (entirely or partially) outside the opening of the structure (as is further seen in FIGS. 3A-3B), in some examples. In the example illustrated in FIGS. 2A-2B, the frame 10 also includes a top interior edge 13a, a bottom interior edge 13b, and two side interior edges 13c and 13d. The interior edges 13 of the frame 10 define an inner perimeter of the frame 10, in the illustrated example. Furthermore, although the flood vent 8 is illustrated as including a single frame 10 and a single door 22, in other examples, the flood vent 8 includes multiple frames 10 and/or multiple doors 10. As one example of this, the flood vent 8 include two frames 10 (or two or more frames 10) stacked on top of each other (and coupled together), along with one or more doors 22 attached to each frame 10. As another example, the flood vent 8 includes two frames 10 (or two or more frames 10) positioned horizontally next to each other (and coupled together), along with one or more doors 22 attached to each frame 10. As a further example, the flood vent 8 includes two frames 10 (or two or more frames 10) stacked on top of each other and two frames 10 (or two or more frames 10) positioned horizontally next to each other (and these four or more frames 10 may be coupled together, or may otherwise be formed as a single piece), along with one or more doors 22 attached to each frame 10. As examples of this, a flood vent 8 includes 1-6 frames 10 positioned horizontally next to each other, along with 1-2 frames 10 stacked on top of each of the horizontally positioned frames 10 (and all of these frames 10 may be coupled together, or may otherwise be formed as a single piece), along with one or more doors 22 attached to each frame 10.

The frame 10 has any shape. In the illustrated example, the frame 10 is rectangular-shaped. The frame 10 has any size and/or dimensions. As one example of this, the top and bottom edges 11a and 11b are approximately 16″ long, and the side edges 11c and 11d are approximately 8″ long, thereby forming an 8″×16″ rectangular outer perimeter. Furthermore, in such an example, the top and bottom rails 12a and 12b are approximately 17 11/16″ long, and the side rails 12c and 12d are approximately 9 11/16″ long. Additionally, when two or more frames 10 are coupled together (as is discussed above), the flood vent 8 has an outer perimeter of, for example, approximately 16″×16″, 8″×32″, 16″×32″, or any other dimensions. The frame 10 is formed of any material. For example, the frame 10 is formed of a corrosion resistant material, such as stainless steel, spring steel, plastic, a polymer, any other corrosion resistant material, or any combination of the preceding.

In the example illustrated in FIGS. 1A-2B, the flood vent 8 further includes a door 22 attached to the frame 10 (or multiple doors 22 attached to multiple frames 10, or multiple doors 22 attached to multiple frames 10 that are formed as a single piece). The door 22 is pivotally mounted to the frame 10, thereby allowing the door 22 to pivot relative to the frame 10, in some examples. In such examples, the door 22 is mounted to the frame 10 in any manner that allows the door 22 to pivot relative to the frame 10. As an example of this, the door 22 includes one or more door pivot pins 86 that extend from the door 22. In such an example, the door pivot pins 86 are configured to be received within door slots 88 disposed within the frame 10. In the example illustrated in FIG. 2B, the door slots 88 are J-shaped (where the top horizontal bar in the “J” prevents the door pivot pin 86 and the door 22 from sliding out of the frame 10 when the door 22 is lifted and pivoted by the flooding fluids, in some examples). In another example, the door slots 88 are T-shaped. Such configurations allow the door pins 86 to rise in the door slots 88, thereby permitting the door 22 to rise in response to flooding, in some examples. Furthermore, in some examples, such configurations prevent the door 22 from being easily removed during flooding conditions and can deter entry by unauthorized persons or pests.

In the example illustrated in FIG. 1A, the door 22 includes solid panels disposed on opposing faces of the door 22. The solid panels prevent (or substantially prevent) air from passing through the door 22, as well as prevent (or substantially prevent) objects, such as small animals, from passing through the door 22, in some examples. Although the door 22 is illustrated as including solid panels, in other examples, the door 22 includes any other type of panels. As an example of this, the door 22 includes mesh grille panels (not shown) that include openings that may allow air to pass through the door. In such an example, the size of the openings are sufficiently small to prevent (or substantially prevent) objects such as small animals from passing through the door 22. As another example, the door 22 includes one or more louvers 58 (such as, for example, four louvers, or any other number of louvers) that can be opened to allow air to pass through the door 22 (e.g., during warmer temperatures), and closed to prevent (or substantially prevent) air from passing through the door 22 (e.g., during colder temperatures). An example of the louvers 58 is illustrated in FIG. 3C. Additionally, in some examples, the louvered door 22 is screened to prevent (or substantially prevent) penetration by small animals. Further details regarding examples of louvers (and the operation of such louvers) is included in U.S. Pat. No. 6,692,187 entitled “Flood Gate For Door,” which is incorporated herein by reference.

In the example illustrated in FIGS. 1A-1B, the door 22 further includes a top edge 24a, a bottom edge 24b, and two side edges 24c and 24d. The edges 24 of the door 22 define an outer perimeter of the door 22, in the illustrated example. The edges 24 of the door 22 have any shape. As an example, the edges 24 of the door 22 are flat, curved, angled, or any combination of the preceding. As is illustrated in FIG. 1B, top edge 24a and bottom edge 24b each include two portions 25 that are angled and meet at a point. The angled portions 25a of top edge 24a and the angled portions 25b of bottom edge 24b have any angle.

FIGS. 3A-3C illustrate an example of a latching mechanism 70 of the flood vent 8 of FIGS. 1-2. In the example illustrated in FIGS. 3A-3C, the flood vent 8 includes a latching mechanism 70 that can lock the door (thereby preventing the door 22 from opening) and that can also release the door 22 (thereby allowing the door 22 to open). This allows the flood vent 8 to provide an entry point and/or exit point in the structure for flooding fluids, such as water, in some examples. In other examples, the flood vent 8 includes multiple latching mechanisms 70 that can respectively lock and release one of multiple doors 22 of the flood vent 8.

The latching mechanism 70 operates by sensing the level or flow of fluids, such as water, passing through the opening in the structure, in some examples. At a preset level or flow of the fluids, the latching mechanism 70 releases the door 22, allowing the fluid to enter/exit the structure, in some examples. Then, when the level of fluid has decreased sufficiently, the door 22 returns to its pre-release position, in some examples. In some examples, remaining debris (if any) may prevent the door 22 from returning to its pre-release position, until the debris is removed. The latching mechanism 70 includes any type of device (or combination of devices) that can perform the above discussed functions. In the example illustrated in FIGS. 3A-3C, the latching mechanism 70 includes one or more floats 72 positioned within the door 22. For example, as is illustrated in FIG. 3C, the latching mechanism 70 include two floats 72 positioned within the door 22. As is illustrated in FIG. 3C, the first float 72a is positioned within the door 22 at a location that is adjacent the side edge 24c of the door 22, and the second float 72b is positioned within the door 22 at a location that is adjacent the side edge 24d of the door 22.

In an example of operation, the floats 72 are lifted and/or lowered by the height or flow of fluid through fluid openings 82 (shown in FIG. 1A) in the door 22. The pin 74 extending from each float 72 is configured to be inserted into an open slot 78 in the frame 10. When the pin 74 is positioned within the open slot 78, the door 22 is prevented from swinging in either direction. An example of this is illustrated in FIG. 3A. Once the floats 72 are lifted by the height or flow of the fluid such that the pin 74 exits the opening of the open slot 78 (or to any other preset level), the pin 74 is no longer constrained by the open slot 78, and the door 22 may rotate in the direction of the current of the fluid, as is illustrated in FIG. 3B. In the illustrated example, the frame 10 also includes a channel 80 (an example of which is illustrated in FIG. 2A), which allows the pin 74 to pass through the frame 10 as the door 22 rotates.

In a further example of operation, the float 72, pin 74, and open slot 78 act as a resetting mechanism. For example, as is illustrated in FIGS. 1A-2B, one or more guides 84 are disposed on the frame 10. The guides 84 are used to position the pin 74 in the open slot 78, in the illustrated example. The guides 84 are used when the door 22 returns to a substantially perpendicular position, which may occur when the level of fluid is lower than the opening in the open slot 78, in some examples. In the illustrated example, the guides 84, which are disposed on both sides of the open slot 78, are angled upward to position the pin 74 upward as the door 22 rotates to a substantially perpendicular position. Once the door 22 reaches this position, the pin 74 can be at the level of the opening of the open slot 78, such that when the pin 74 is positioned over the open slot 78, the pin 74 can fall into the open slot 78, thereby resetting the latching mechanism 70, in some examples. Further details regarding examples of latching mechanism 70 are included in U.S. Pat. No. 6,692,187 entitled “Flood Gate For Door,” which is incorporated herein by reference.

As is discussed above, in some examples, a flood vent includes a latching mechanism that may release the door of the flood vent, allowing the door to open so that flooding fluids, such as water, may enter and/or exit a structure. Traditional latching mechanisms, however, may be deficient because they may release the door at an inconsistent level of fluid and/or an inconsistent flow of fluid. As one example of this, traditional latching mechanisms may release the door at a water level of, for example, anywhere between 3 inches and 6 inches. This means that, in some examples, the door may be released at a water level of 3 inches, while in other examples, the same door may not be released until the water reaches a water level of 5 or even 6 inches. Contrary to this, the float 172 discussed below may address this deficiency by, for example, providing more consistency in the release of the door of the flood vent.

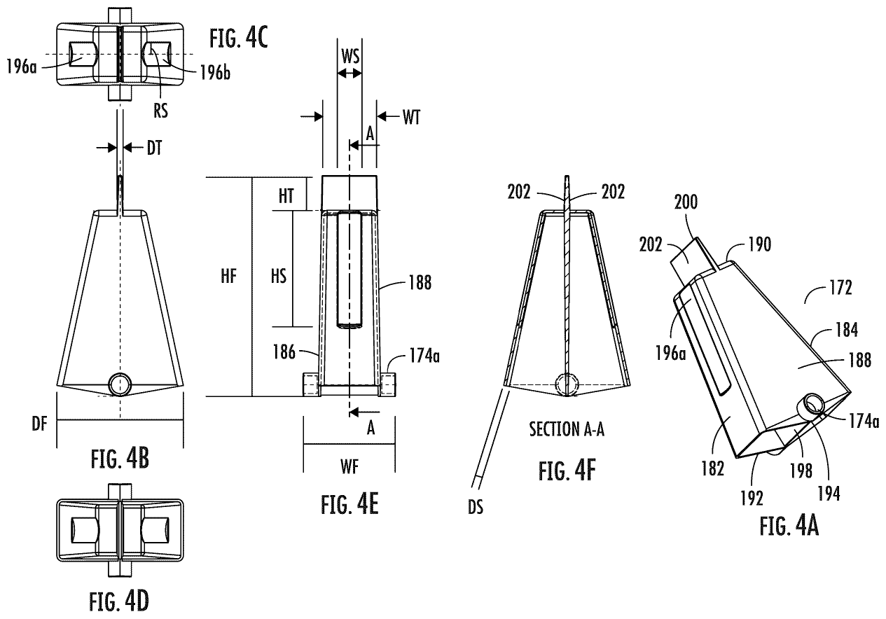

FIGS. 4A-4F illustrate an example of the float 172 that may be used in the latching mechanism for a flood vent, such as the flood vent 8 of FIGS. 1A-3C. In the example illustrated in FIGS. 4A-4F, the float 172 includes a slot 196 that collects fluids (e.g., water) and directs the fluids upwards along a front surface (or back surface) of the float 172. In some examples, this direction of the fluids (and the resulting force) can cause the float 172 to at least partially tip over, which can assist the releasing the door of a flood vent. This allows, in some examples, the door to be released more consistently, such as, for example, consistently at a water level of approximately 3 inches. Additionally, in some examples, this also allows the door to be released at a lower average water level, such as, for example, an average water level of approximately 3 inches.

In the example illustrated in FIGS. 4A-4E, the float 172 operates as an actuating structure in a latching mechanism. By doing so, the float 172 translates the force of flowing fluids into a lifting force that releases and opens the door of a flood vent, for example. As one example of this, as fluids enter a flood vent in which the float 172 is installed, the float 172 is lifted, lowered, and/or tilted by the height or flow of the fluid.

In the illustrated example, the float 172 includes a front surface 182, a back surface 184, two side surfaces 186 and 188, a top surface 190, and a bottom surface 192. When the float 172 is installed in a flood vent, the front surface 182 faces toward an entry point/exit point in the flood vent, while the back surface 184 forces toward the opposing entry point/exit point in the flood vent, in some examples. In such examples, the front surface 182 and the back surface 184 face towards (or away from) the direction of inward and outward fluid flow within the flood vent.

The side surfaces 186 and 188 extend in-between the front surface 182 and the back surface 184, in the illustrated example. When the float 172 is installed in a flood vent, the side surfaces 186 and 188 face toward one of the side edges 24c and 24d of the door 22, in some examples. The top surface 190 also extends in-between the front surface 182 and the back surface 184, in the illustrated example. When the float 172 is installed in a flood vent, the top surface 190 faces toward the top edge 24a of the door 22, in some examples.

In the illustrated example, the bottom surface 192 refers to the bottom edge of the float 172 that is defined by the bottom edges of each of the front surface 182, the back surface 184, and the side surfaces 186 and 188. This causes, in the illustrated example, the bottom of the float 172 to be open to the environment (e.g., open and hollow). As such, when fluid flows within the flood vent 8, the fluid may enter the float 172 through the bottom of the float 172. When this occurs, in some examples, the Bell Jar effect traps air in the hollow cavity adding buoyancy. Furthermore, in some examples, the weight of the material of the float 172 (e.g., polypropylene, another material with a specific gravity less than 1) allow the float 172 to always float no matter if it is full of water or air. Although the bottom of the float 172 is illustrated as being open to the environment (e.g., open and hollow), in other examples, the float 172 has a bottom surface 192 that encloses (entirely or substantially) the float 172, thereby causing the float 172 to be closed (or substantially closed) to the environment.

Collectively, the front surface 182, back surface 184, two side surfaces 186 and 188, top surface 190, and the bottom surface 192 define the general shape of the float 172. The float 172 has any shape, such as any shape that allows the float 172 to translate the force of flowing fluids into a lifting force that releases and opens the door 22 of the flood vent 8, in some examples. In the illustrated example, the front surface 182 and back surface 184 flare outwardly away from each other, so that a top portion of the float 172 is narrower than a bottom portion of the float 172. Furthermore, in the illustrated example, the bottom portion of the two side surfaces 186 and 188 extends downward at an angle to form a pivot point 194 that is vertically lower than the bottom edges of the front surface 182 and back surface 184. In some examples, this pivot point 194 allows the float 172 to rock back and/or forth, which can assist the float 172 in tipping over, so as to release the door.

Additionally, in the illustrated example, the float 172 includes a hollow interior (or substantially hollow interior). This decreases the weight of the float 172 and allows fluid to enter and fill the interior of the float 172, in some examples. In some examples, the hollow interior is separated into two chambers by an internal surface 198 that extends downward from the bottom of the top surface 190 to the bottom surface 192, as is illustrated in FIGS. 4A-4F.

In the example illustrated in FIGS. 4A-4F, the float 172 further includes one or more pins 174 that each extend outward from one of the side surfaces 186 and 188. For example, in the illustrated example, the float 172 includes a first pin 174a that extends outward from the side surface 188, and a second pin 174b that extends outward from the side surface 186. The pin 174 extending from a float 172 is configured to extend out of the side of the door 22 (an example of which is illustrated in FIG. 3C) and be inserted into an open slot 78 in the frame 10 of the flood vent 8. When the pin 174 is positioned within the open slot 78, the door 22 is prevented from swinging in either direction, in some examples. Once the float 172 is lifted (or tilted) by the height or flow of the fluid such that the pin 174 exits the opening of the open slot 78 (or to any other preset level), the pin 174 may no longer be constrained by the open slot 78, and the door 22 may rotate in the direction of the current of the fluid. An example of this is further described below.

In the example illustrated in FIGS. 4A-4F, the float 172 further includes one or more slots 196 (e.g., slots 196a and 196b) positioned in the front surface 182 and/or the back surface 184. In the illustrated example, the slot 196 collect fluids (e.g., water) and directs the fluids upwards along the front surface 182 or the back surface 184 of the float 172. In some examples, this direction of the fluids (and the resulting force) may cause the float 172 to at least partially tip over, which can assist in releasing the door of a flood vent. This allows, in some examples, the door to be released more consistently, such as, for example, consistently at a water level of approximately 3 inches. Additionally, in some examples, this also allows the door to be released at a lower average water level, such as, for example, an average water level of approximately 3 inches. In some examples, the slot 196 is referred to as a directed water slot 196.

In the illustrated example, the slot 196 is a closed slot that does not have any holes in it. As such, the slot 196 does not allow the fluids to enter inside the interior of the float 172 via the slot 196. Instead, as is discussed above, the fluids can enter the slot 196, where they are collected and directed upwards along the front surface 182 or the back surface 184 of the float 172.

The float 172 includes any number of slots 196. In the illustrated example, the float 172 includes two slots 196: a first slot 196a positioned in the front surface 182 and a second slot 196b positioned in the back surface 184. In other examples, the float 172 includes two or more slots 196 positioned in the front surface 182, and two or more slots 196 positioned in the back surface 184. In other examples, the float 172 includes one or more slots 196 positioned in the front surface 182 (or the back surface 184), but does not include any slots 196 in the other of the front surface 182 and the back surface 184.

The slot 196 is positioned in any location in the front surface 182 or the back surface 184. In the illustrated example, the slot 196 is positioned in the middle of the width of the front surface 182 (or the back surface 184), and the slot 196 is further positioned to extend up to at least touch the top surface 190 of the float 172. In some examples, the slot 196 is positioned to extend into a portion of the top surface 190 of the float 172.

The slot 196 has any shape. For example, the slot 196 has any shape that allows it to collect fluids (e.g., water) and direct the fluids upwards along the front surface 182 or the back surface 184 of the float 172. Example shapes of the slot 196 include a polyhedron (e.g., a rectangular polyhedron, a triangular polyhedron), a cube, a cone, a pyramid, any other shape, any portion of the shape, or any combination of the preceding. In the illustrated example, the slot 196 is shaped as a portion of a cylinder (i.e., a cylinder that has been cut along its length).

The slot 196 has any size. For example, the slot 196 has any size that allows it to collect fluids (e.g., water) and direct the fluids upwards along the front surface 182 or the back surface 184 of the float 172. In some examples, the slot 196 has a height (HS) of 1-2 inches (e.g., 1.85 inches), a width (WS) of 0.25-0.75 inches (e.g., 0.5 inches), a radius (RS), if applicable, of 0.20-0.60 inches (e.g., 0.25 inches or 0.5 inches), and a depth (DS) of 0.02-0.06 inches (e.g., 0.040 inches). In other examples, the slot 196 has a height (HS) that is ⅓-¾ (e.g., ½) of the height (HF) of the float 172, a width (WS) that is ¼-½ (e.g., ⅓) of the width (WF) of the float 172, a radius (RS), if applicable, that is ⅛-½ (e.g., ⅙ or ⅓) of the width (WF) of the float 172, and a depth (DS) that is 1/75- 1/25 (e.g., 1/50) of the depth (DF) of the float 172.

Furthermore, although the dimensions of the slot 196 are illustrated as being fixed, in some examples, one or more of the dimensions are variable. For example, the depth of the slot 196 may change along the height of the slot 196 (e.g., the depth may increase as the slot 196 extends upward along the height of the float 172), the width of the slot 196 may change along the height of the slot 196 (e.g., the width may increase as the slot 196 extends upward along the height of the float 172), any other dimension may be variable, or any combination of the preceding.

In the example illustrated in FIGS. 4A-4F, the float 172 further includes a tab 200 positioned on and extending upward from the top surface 190. In the illustrated example, the tab 200 operates as a target for the fluids (e.g., water) directed upwards by the slot 196. In some examples, the impact of the fluids on the tab 200 assists in causing the float 172 to at least partially tip over, which can assist in releasing the door 22 of a flood vent 8.

In the illustrated example, the tab 200 includes a front surface 202 that faces toward an entry point/exit point in the flood vent, and a back surface 204 that faces toward the opposing entry point/exit point in the flood vent, in some examples. In such examples, the front surface 202 of the tab 200 and the back surface 204 of the tab 200 face towards (or away from) the direction of inward and outward fluid flow within the flood vent.

The tab 200 is positioned in any location on the top surface 190. In the illustrated example, the tab 200 is positioned in the middle of the depth of the top surface 190.

The tab 200 has any shape. For example, the tab 200 has any shape that allows it to operate as a target for the fluids (e.g., water) directed upwards by the slot 196. Example shapes of the slot 196 include a polyhedron (e.g., a rectangular polyhedron, a triangular polyhedron), a cube, a cone, a pyramid, any other shape, any portion of the shape, or any combination of the preceding. In the illustrated example, the tab 200 is shaped as rectangular polyhedron, with a depth that varies along the height of the tab 200.

The tab 200 has any size. For example, the tab 200 has any size that allows it to operate as a target for the fluids (e.g., water) directed upwards by the slot 196. In some examples, the tab 200 has a height (HT) of 0.3-0.85 inches (e.g., 0.56 inches), a width (WT) of 0.75-1.20 inches (e.g., 0.90 inches), and a depth (DT) of 0.05-0.25 inches (e.g., 0.10 inches). In other examples, the tab 200 has a height (HT) that is 1/9-¼ (e.g., ⅙) of the height (HF) of the float 172, a width (WT) that is ¼-¾ (e.g., ⅔) of the width (WF) of the float 172, and a depth (DT) that is 1/40-⅕ (e.g., 1/20) of the depth (DF) of the float 172.

Furthermore, each (or one or more of) the dimensions of the tab 200 may be either fixed or variable. In the illustrated example, the depth of the tab 200 changes along the height of the tab 200 (e.g., the depth decreases as the tab 200 extends upward along its height), and the width of the tab 200 changes along the height of the tab 200 (e.g., the width decreases as the tab 200 extends upward along its height). In other examples, one or more (or all) of these dimensions are fixed. In further examples, all of the dimensions are variable.

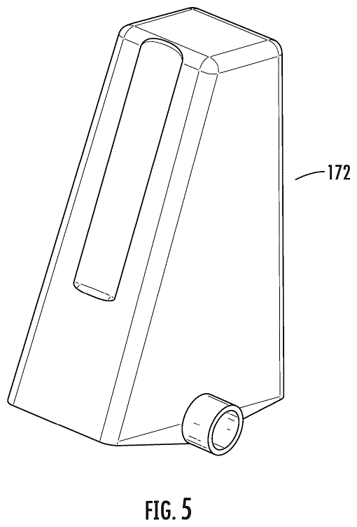

Although the float 172 is illustrated in FIGS. 4A-4F as including a tab 200, in other examples the float 172 does not include a tab 200. FIG. 5 illustrates an example of float 172 that does not include a tab 200.

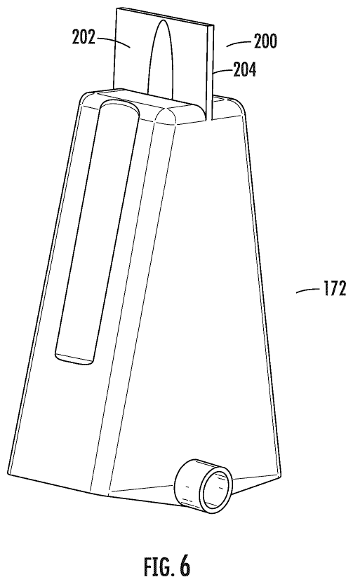

Furthermore, although the float 172 is illustrated in FIGS. 4A-4F as including a tab 200 having front and back surfaces 202 and 204 that are flat, in other examples, the float 172 includes a tab 200 having front and back surfaces 202 and 204 with slots (e.g., directed water slots) positioned in them. FIG. 6 illustrates an example of a float 172 that includes a tab 200 having front and back surfaces 202 and 204 with slots (e.g., directed water slots) positioned in them. The slots in front and back surfaces 202 and 204 are similar to slots 196 discussed above. However, in the illustrated example of FIG. 6, the slots have a different shape and size than slots 196.

The float 172 is made of any material. For example, the float 172 is made of any material that allows the float 172 to operate as an actuating structure in a latching mechanism of a flood vent, such as, for example, by translating the force of flowing fluids into a lifting force that releases and opens the door 22 of a flood vent 8, for example. In some examples of this, the float 172 is made of polypropylene, nylon, polyethylene, any other thermoplastic, cork, foam, any other material (or combination of materials) with a specific gravity less than 1, any other material that allows the float 172 to perform one or more (or all) of the functions discussed above, or any combination of the preceding. The float 172 is manufactured in any manner. As an example of this, the float 172 is manufactured using one or more molds.

In some examples, all or a portion of the float 172 includes any suitable coating or polish, such as, for example, a paint, a finish, any other coating or polish, or any combination of the preceding. In some examples, all or a portion of the float is sanded (e.g., sanded down to a standard finish) or un-sanded. In some examples, the pins 174 of the float 172 are sanded using, for example, 400-grit sandpaper and/or a light Emory cloth finish.

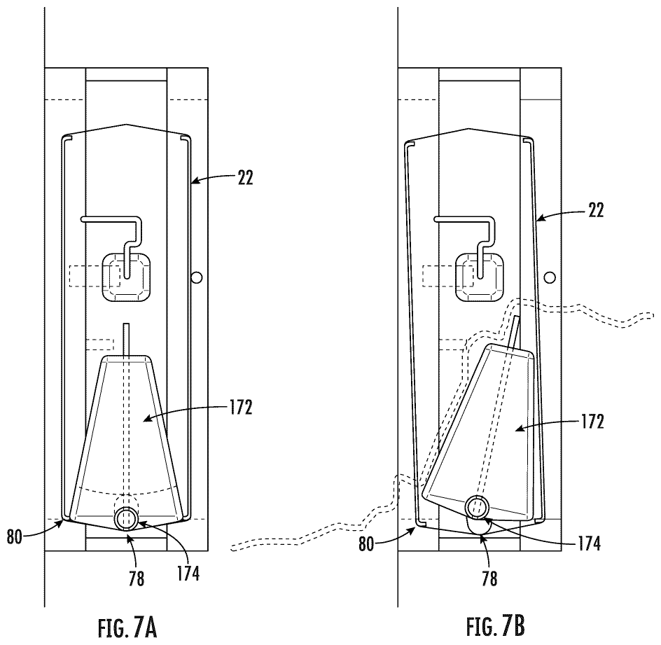

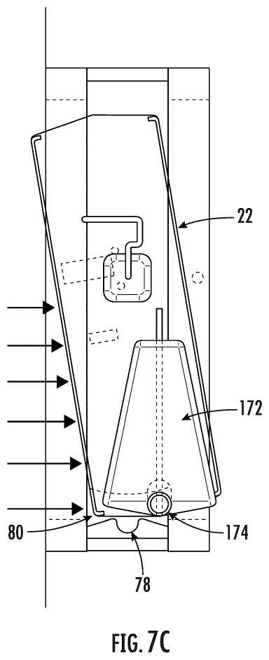

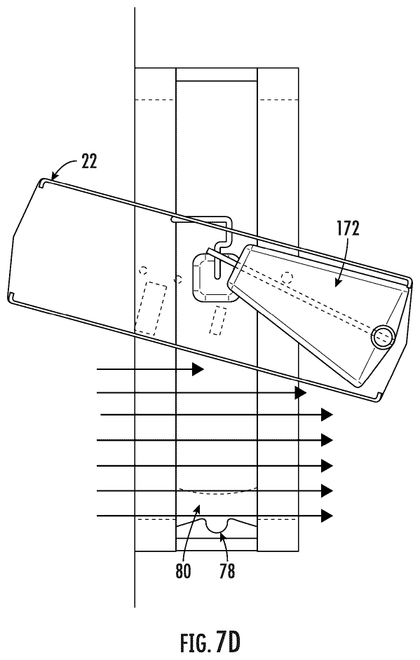

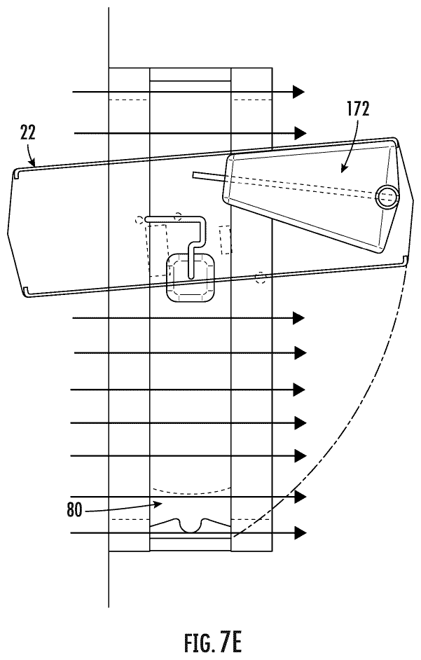

FIGS. 7A-7E illustrate an example of a door 22 of a flood vent 8 being opened by the force of a flowing fluid. FIG. 7A shows the position of the float 172 when the fluid level within the flood vent 8 is not sufficient to displace the float 172. In the illustrated example, the door 22 is in a vertical, closed position, and the pin 174 is seated in the open slot 78. As a result of the pin 174 being seated in the open slot 78, the float(s) 172 prevent(s) the door 22 from pivoting open, in some examples.

In the example illustrated in FIG. 7B, when a flooding event occurs, flowing fluid (e.g., water) enters the door 22 through the fluid openings 82 in the door 22. The flowing fluid is collected by the slot 196 and directed up the front surface 182 (or back surface 184, depending on the direction of the flow of the flowing fluid) of the float 172. This directed fluid impact (or otherwise flow into) the tab 200. If the resulting force is sufficient, the float 172 at least partially tips over on the pivot point 194. This motion can lift the float pin 174 out of the open slot 78 (as is seen in FIG. 7B), which releases the door 22 (thus permitting the door 22 to swing open with the flow of the fluid).

In the example illustrated in FIGS. 7C and 7D, the force of the flowing fluid pushes against the released door 22, thereby forcing the door 22 into the open position. In the example illustrated in FIG. 7E, once the door 22 has rotated into the fully open position, the force of the current and the buoyancy of the float 172 can maintain the door 22 in the open position.

After the fluid level has dropped, the above-described arrangement of the float 172, the pin 174, frame 10, and the open slot 78 function as a resetting mechanism, in some examples. That is, when the fluid level has sufficiently receded, the float 172 tilts on the pivot point 194 back to its original position, and the float pin 174 rotated back into the open slot 78 to latch the door 22.

In the event that the incoming fluid rises slowly and does not have sufficient current flow to push the float 172, the buoyancy of the float 172 can lift the float pin 174 out of the open slot 78, and the door 22 can be released in the manner described in the previous example. The door 22 can thus be released by the force of flowing fluid pushing on the float 172, by the buoyancy of the float 172, or by a combination of these two methods working in cooperation to release the door 22.

Modifications, additions, or omissions may be made to the flood vents 8 and/or floats 172 without departing from the scope of the disclosure. Furthermore, the disclosure of each of FIGS. 1A-7E may be combined with one or more (or all) of any of the other disclosures of FIGS. 1A-7E. Furthermore, although the float 172 has been described above as being used with a flood vent 8, in other examples, the float 172 is used with any other suitable flood vent or any other suitable mechanism, device, and/or product.

This specification has been written with reference to various non-limiting and non-exhaustive examples. However, it will be recognized by persons having ordinary skill in the art that various substitutions, modifications, or combinations of any of the disclosed examples (or portions thereof) may be made within the scope of this specification. Thus, it is contemplated and understood that this specification supports additional examples not expressly set forth in this specification. Such examples may be obtained, for example, by combining, modifying, or reorganizing any of the disclosed steps, components, elements, features, aspects, characteristics, limitations, and the like, of the various non-limiting and non-exhaustive examples described in this specification.

1. A flood vent, comprising:
a frame configured, when installed in an opening in a structure, to form a fluid passageway through the opening in the structure;
a door configured to be pivotally mounted to the frame;
a first float positioned partially within the door; and
a second float positioned partially within the door;
wherein each of the first float and the second float comprise:
a front surface, a back surface, two side surfaces, a top surface, and a bottom surface;
a first closed slot positioned in the front surface;
a second closed slot positioned in the back surface; and
a pin that extends outward from a first side surface of the two side surfaces so as extend out of the door.

2. The flood vent of claim 1, wherein each of the first float and the second float further comprise a second pin that extends outward from a second side surface of the two side surfaces.

3. The flood vent of claim 1, wherein each of the first float and the second float further comprise a tab that is positioned on and extends upward from the top surface.

4. The flood vent of claim 3, wherein the tab of each of the first float and the second float comprises a flat front surface and a flat back surface.

5. The flood vent of claim 3, wherein each of the first float and the second float further comprise:
a third closed slot positioned in a front surface of the tab; and
a fourth closed slot positioned in a back surface of the tab.

6. The flood vent of claim 1, wherein each of the first closed slot and the second closed slot of each of the first float and the second float is shaped as a portion of a cylinder.

7. The flood vent of claim 1, wherein each of the first closed slot and the second closed slot of each of the first float and the second float has a height of 1-2 inches, a width of 0.25-0.75 inches, and a depth of 0.02-0.06 inches.

8. The flood vent of claim 1, wherein each of the first closed slot and the second closed slot of each of the first float and the second float has a height that is ⅓-¾ of a height of a respective float of the first float and the second float, a width that is ¼-½ of a width of the respective float of the first float and the second float, and a depth that is 1/75- 1/25 of a depth of the respective float of the first float and the second float.

9. The flood vent of claim 1, wherein each of the first float and the second float is made from polypropylene.

10. The flood vent of claim 1, wherein each of the first float and the second float is made from one or more materials having a specific gravity less than 1.

11. A float for a door of a flood vent, the float comprising:
a front surface, a back surface, two side surfaces, a top surface, and a bottom surface;
a first closed slot positioned in the front surface;
a second closed slot positioned in the back surface; and
a pin that extends outward from a first side surface of the two side surfaces.

12. The float of claim 11, further comprising a second pin that extends outward from a second side surface of the two side surfaces.

13. The float of claim 11, further comprising a tab that is positioned on and extends upward from the top surface.

14. The float of claim 13, wherein the tab comprises a flat front surface and a flat back surface.

15. The float of claim 13, further comprising:
a third closed slot positioned in a front surface of the tab; and
a fourth closed slot positioned in a back surface of the tab.

16. The float of claim 11, wherein each of the first closed slot and the second closed slot is shaped as a portion of a cylinder.

17. The float of claim 11, wherein each of the first closed slot and the second closed slot has a height that is ⅓-¾ of a height of the float, a width that is ¼-½ of a width of the float, and a depth that is 1/75- 1/25 of a depth of the float.

18. The float of claim 11, wherein the float is made from polypropylene.

19. The float of claim 11, wherein the float is made from one or more materials having a specific gravity less than 1.

20. The float of claim 11, wherein the float is made from cork or foam.
